(19) United States
(12) Patent Application Publication
(10) Pub. No.: US 2007/0068017 A1
(43) Pub. Date: Mar. 29, 2007

(54) Optical pet guiding apparatus

(75) Inventors: Yuji Tamura, Akashi-shi (JP); Hiroyuki Wada, Kobe-shi (JP); Akihisa Yamashita, Kobe-shi (JP)

Correspondence Address: JORDAN AND HAMBURG LLP, 122 EAST 42ND STREET, SUITE 4000, NEW YORK, NY, 10168, US

(73) Assignee: Konami Sports & Life Co., Ltd., Shinagawa-ku (JP)

(21) Appl. No.: 11/526,438

(22) Filed: Sep. 25, 2006

(30) Foreign Application Priority Data
Sep. 26, 2005 (JP) 2005-278796

(51) Int. Cl. G01C 15/00

(52) U.S. Cl. 33/227

(57) ABSTRACT

An optical pet guiding apparatus is provided with a light emitting section for emitting a light beam in a specified direction, direction changing sections for changing the facing direction of the light emitting section in a two-dimensional direction, and motors for causing the direction changing sections to change the facing direction of the light emitting section. The direction changing sections include a transversely changing section for rotating the light emitting section about a vertically extending shaft and a vertically changing section for rotating the light emitting section about a transversely extending shaft, and moves a light beam as a spotlight on a floor surface to guide a pet.

### BACKGROUND OF THE INVENTION

1. Field of the Invention

The present invention relates to an optical pet guiding apparatus for guiding pets such as dogs and cats to suitably exercise in house.

2. Description of the Background Art

As an optical pet guiding apparatus of this type, Japanese Unexamined Patent Publication No. 2002-176873 discloses an apparatus in which a laser beam is projected as a spotlight onto a floor surface via a reflector, the reflector is rotated to move the spotlight in a rotating pattern on the floor surface, thereby letting pets such as dogs and cats think the spotlight as an insect so that the pets are let to play and do a specified exercise while having their hunting instincts roused.

Specifically, the above optical pet guiding apparatus causes the spotlight projected from the apparatus to make impalpable transverse movements in addition to circular movements on the floor surface by inclining a reflecting mirror by means of an eccentric rotating cam if necessary while rotating a major part of the apparatus including the reflecting mirror about an axis displaced from an optical axis of the reflecting mirror, thereby generating a Lissajous waveform to simulate movements of insects and the like.

However, the conventional optical pet guiding apparatus has such a basic construction of rotating the reflecting mirror inside or the major part of the apparatus including the reflecting mirror about the axis displaced from the optical axis and, therefore, cannot go beyond the bounds of moving the spotlight along circular paths. Thus, there has been a certain limit in moving the spotlight projected on the floor along a wide variety of paths (light projection patterns).

### SUMMARY OF THE INVENTION

It is an object of the present invention to provide an optical pet guiding apparatus which is free from the problems residing in the prior art.

It is another object of the present invention to provide an optical pet guiding apparatus which can project a spotlight along a desired path on a surface such as a floor surface.

It is still another object of the present invention to provide an optical pet guiding apparatus which can change a guiding range for a pet.

According to an aspect of the invention, an optical pet guiding apparatus comprises a light emitter for emitting a light beam in a specified direction, a direction changer for changing the facing direction of the light emitter in a two-dimensional direction, and a drive controller for causing the direction changer to change the facing direction of the light emitter. These elements are provided in an apparatus main body. The direction changer includes a first rotator for rotating the light emitter about a first shaft and a second rotator for rotating the light emitter about a second shaft normal to the first shaft. The drive controller rotates the first and second rotators, respectively.

These and other objects, features, aspects and advantages of the present invention will become more apparent upon a reading of the following detailed description and accompanying drawings.

### BRIEF DESCRIPTION OF THE DRAWINGS

FIG. 1 is a perspective view showing an external configuration of an optical pet guiding apparatus according to an embodiment of the invention,

FIG. 2 is an exploded perspective view of the optical pet guiding apparatus,

FIG. 3 is a vertical section of the optical pet guiding apparatus,

FIG. 4 is a view seen in a direction of arrows IV-IV in FIG. 3,

FIG. 5 is a view seen in a direction of arrows V-V in FIG. 3,

FIG. 6 is a perspective view showing a state placed on a horizontal surface,

FIG. 7 is a construction diagram of a remote controller,

FIG. 8 is a diagram showing a schematic function block of the optical pet guiding apparatus,

FIG. 9 is a block diagram of the optical pet guiding apparatus,

FIG. 10 is a diagram showing a projection range,

FIG. 11 is a chart showing light projection pattern modes of a spotlight SL within the projection range,

FIG. 12 is a table showing sound patterns,

FIG. 13 is a main flow chart,

FIG. 14 is a flow chart showing a subroutine “Initialization”,

FIG. 15 is a flow chart showing a subroutine “Light Setting”,

FIG. 16 is a flow chart showing a subroutine “Training”, and

FIG. 17 is a flow chart showing a subroutine “Free Mode”.

### DETAILED DESCRIPTION OF THE PREFERRED EMBODIMENTS OF THE INVENTION

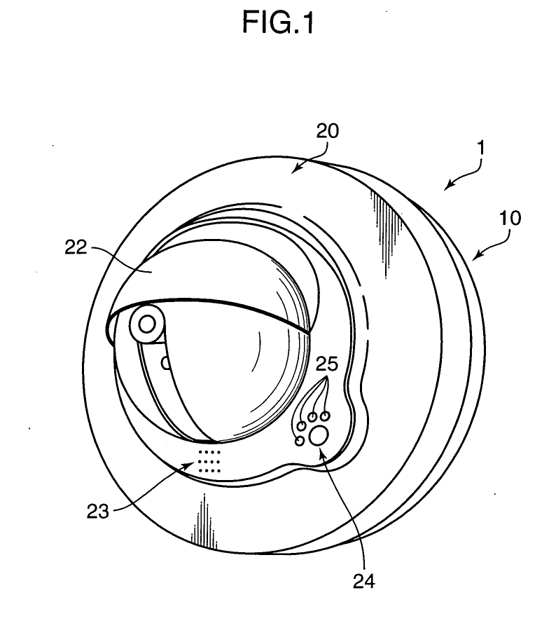

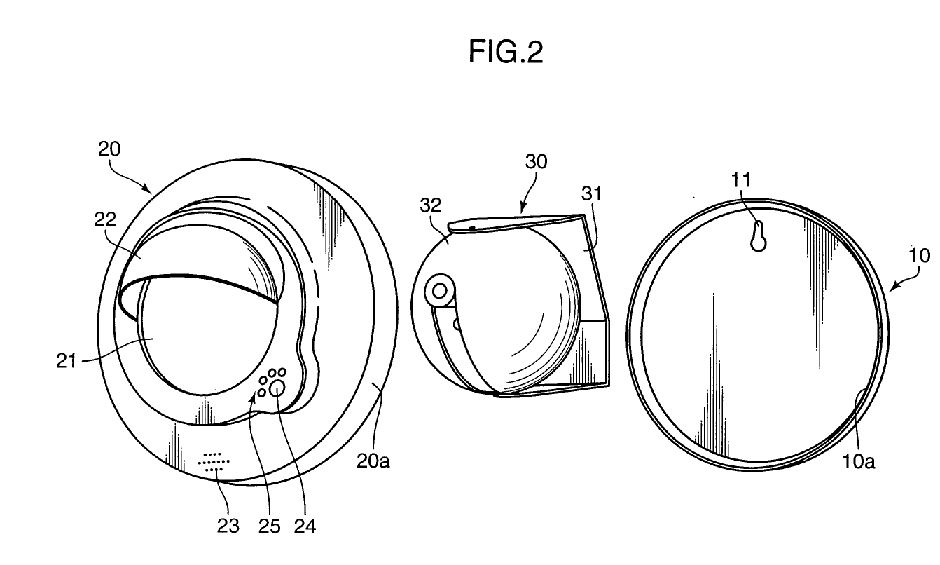

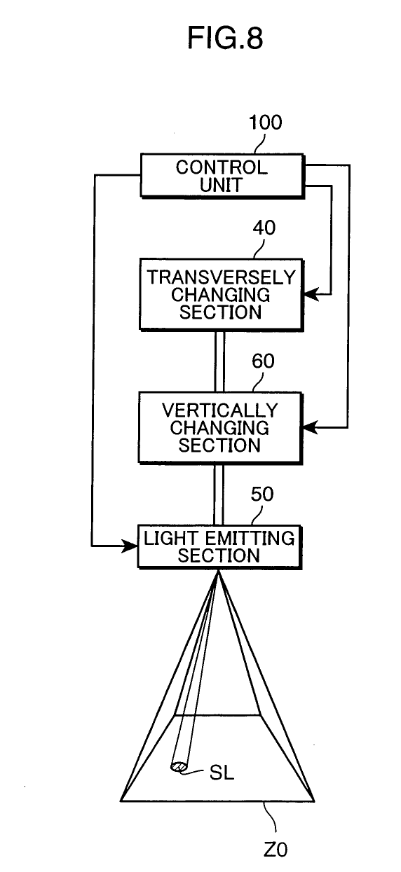

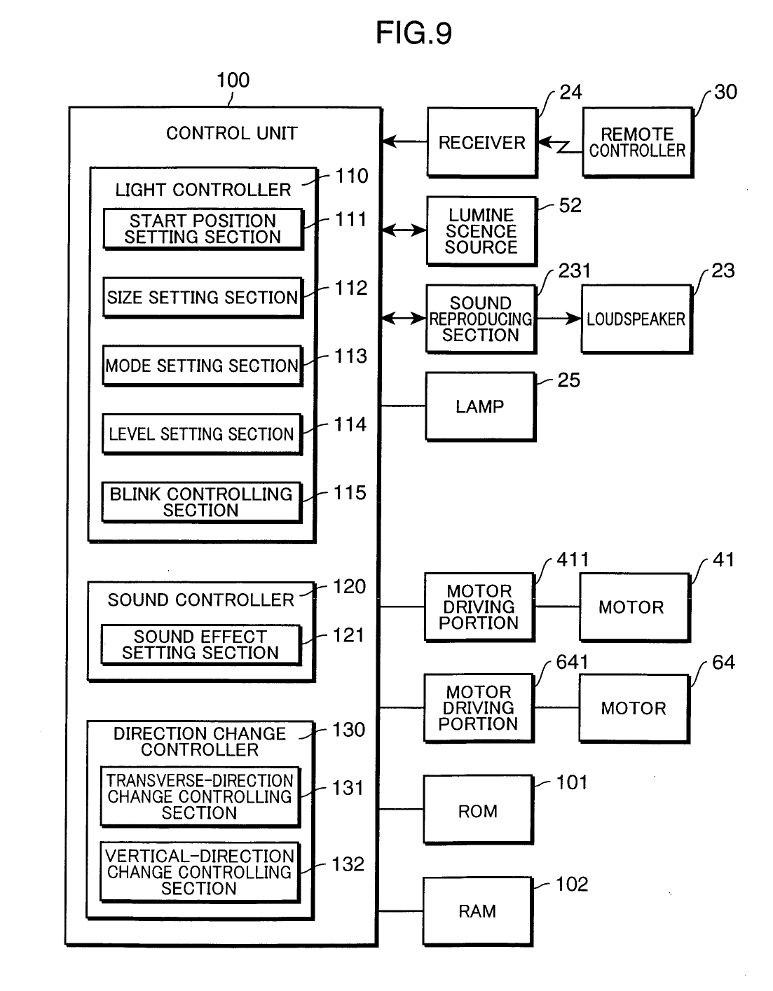

FIG. 1 is a perspective view showing the external configuration of one embodiment of an optical pet guiding apparatus according to the invention, and FIG. 2 is an exploded perspective view of FIG. 1. The optical pet guiding apparatus 1 is comprised of an apparatus main body including a round back cover 10 formed with a standing edge 10a of a specified height at the peripheral edge thereof and a round front cover 20 fitted into the standing edge 10a of the back cover 10 and similarly formed with a standing edge 20a at the peripheral edge thereof, and a projecting unit 30 secured to the bottom surface of the back cover 10 by a fastener such as a screw and mounted in an inner space defined between the back cover 10 and the front cover 20. Although not shown, a circuit board having electronic devices mounted thereon, wiring with a power supply, a secondary battery in the case of an embodiment driven by a battery and the like for constructing a control unit 100 (see FIGS. 8 and 9) for controlling the operation of this apparatus are mounted in the inner space between the back cover 10 and the front cover 20 except a place where the projecting unit 30 is mounted.

The projecting unit 30 includes a bracket 31 substantially U-shaped in side view, and a hollow body having a specified shape, i.e. a hollow spherical body 32 in this embodiment, rotatably supported on the bracket 31. In the center of the front cover 20 is formed an opening 21 dimensioned in conformity with the diameter of the spherical body 32, and an eave 22 having a tetraspherical shape is formed at an upper part of the opening 21. Further, a loudspeaker 23 for outputting sound effects, a receiver 24 for receiving an operation instruction signal from a remote controller to be described later, and lamps 25 such as LEDs for making notifications, for example, when the power supply is turned on and off and when the apparatus main body is in an operating state are provided at specified positions on the front surface of the front cover 20. A gourd-shaped locking hole 11 is formed at a specified upper position of the bottom surface of the back cover 10, so that this apparatus 1 can be positioned and fixed to an unillustrated hook member projecting, for example, from a wall of a room.

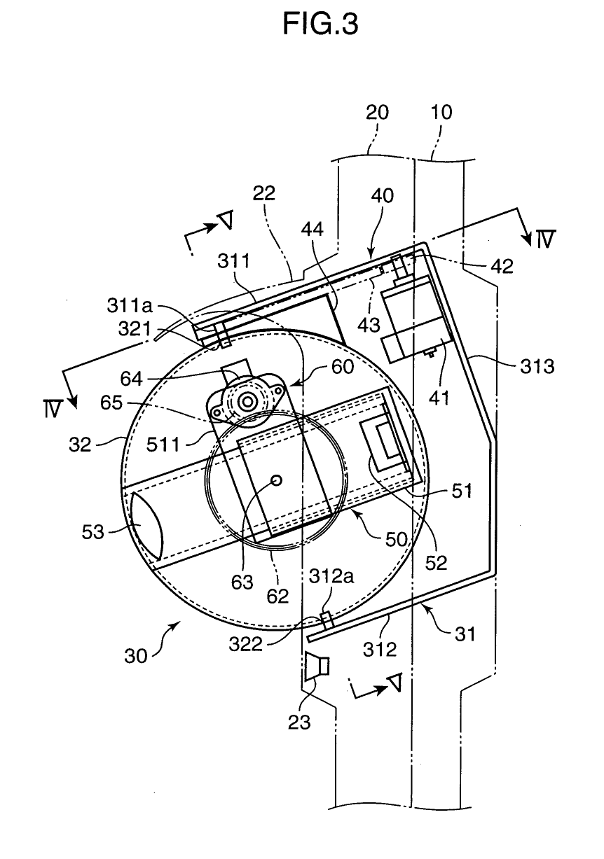

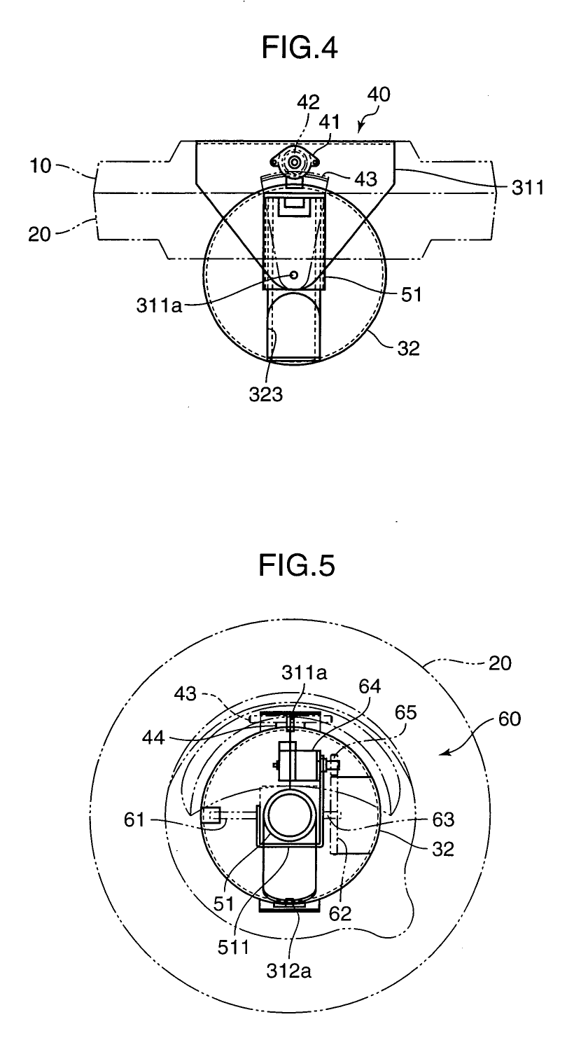

FIG. 3 is a vertical section of the optical pet guiding apparatus, FIG. 4 is a view seen in a direction of arrows IV-IV of FIG. 3 and FIG. 5 is a view seen in a direction of arrows V-V of FIG. 3. FIGS. 3 to 5 shows a normal state in use where this apparatus 1 is hooked to a wall of a room.

The bracket 31 substantially U-shaped in side view has a ceiling plate portion 311 and a bottom plate portion 312 parallel to each other and a coupling plate portion 313 coupling the rear ends of both plate portions 311, 312. The ceiling plate portion 311 and the bottom plate portion 312 are so formed to be narrowed toward their leading ends as to be accommodated inside the eave 22.

An upper shaft 311a and a lower shaft 312a are mounted at positions of the ceiling plate portion 311 and the bottom plate portion 312 facing each other. On the other hand, shaft holes 321, 322 are formed at positions in the outer surface of the spherical body 32 facing the upper and lower shafts 311a, 312a. The upper and lower shafts 311a, 312a are loosely fitted into these shaft holes 321, 322, whereby the spherical body 32 is rotatably supported between the upper and lower shafts 311a, 312a.

A motor 41 is mounted at a specified position on the inner wall of the bracket 31, and a gear 42 is integrally rotatably coupled to a rotary shaft of the motor 41. Further, a fan-shaped gear 43 is fitted on the upper shaft 311a. The fan-shaped gear 43 and the outer surface of the spherical body 32 are so fixed to each other via a coupling member 44 as to be integrally rotatable. The gear 42 and the fan-shaped gear 43 are engaged with each other. When the motor 41 is rotated, the gear 43 turns, i.e. the spherical body 32 rotates about an axis connecting the upper and lower shafts 311a, 312a.

The spherical body 32 is an opaque hollow body integrally formed, for example, by fitting semispherical bodies together. In the outer surface of the spherical body 32, a cutout 323 having a specified width is formed, as a projection window, from the shaft hole 322 to a substantially middle position between the shaft holes 321, 322.

A tubular light emitting section 50 for emitting a light beam and a vertically changing section 60 for changing a projecting direction of the light beam from the light emitting section 50 along vertical direction are mounted inside the spherical body 32. It should be noted that the motor 41 (corresponding to a first driving portion), the gear 42, the fan-shaped gear 43 and the coupling member 44 (corresponding to a first power transmitting portion) described above construct a transversely changing section 40 (corresponding to first rotator), which constructs a direction changer together with the vertically changing section 60 (corresponding to second rotator).

Inside the spherical body 32, a shaft 61 of the vertically changing section 60 is mounted at one (left in FIG. 5) of transversely opposed positions, and a gear 62 thereof having a specified diameter is mounted at the other position. The gear 62 is fixed to the spherical body 32. The light emitting section 50 is so supported at a substantially longitudinal middle position of its tubular body between the shaft 61 and a central shaft 63 of the gear 62 as to be rotatable in a vertical plane (vertically pivot).

More specifically, a motor 64 is secured to a tubular body 51 of the light emitting section 50 via a bracket 511 supporting the tubular body 51, and a gear 65 mounted on an output shaft thereof is engaged with the gear 62. When the motor 64 is rotated, the gear 65 rotates, whereby the motor 64 itself turns around the secured gear 62. Consequently, the tubular body 51 rotates about an axis connecting the shafts 61, 63 via the bracket 511.

The light emitting section 50 has the round and bottomed tubular body 51 having such a length as not to touch the inner wall of the spherical body 32, and a luminescence source 52 such as an LED (including laser emission) is mounted at the bottom of the tubular body 51. Various luminescent colors can be adopted, but colors that can assist playgames or exercises by being interested by pets such as dogs and cats (by rousing hunting instincts) are preferable. In this embodiment, green is adopted. The luminescence source 52 is for emitting a light having forward directivity in the longitudinal direction of the tubular body 51, and a condenser lens 53 is mounted at the leading end of the tubular body 51. The light from the luminescence source 52 is projected forward as a specified light beam by this lens 53. Various sources can be adopted as the luminescence source 52 provided that a specified luminance is obtained, and the beam can be made into a specified condensed or parallel light or a specified diffused light. In this way, the diameter of a spotlight SL on the floor surface can be set.

With the above construction, the light beam from the lens 53 has the projecting direction thereof changed by the transversely changing section 40 (corresponding to the first rotator) and the vertically changing section 60 (corresponding to the second rotator). Further, an optical axis of the light beam intersects with vertical and transverse axes of rotation so as to facilitate the drive control of the motors 41, 61 as described later.

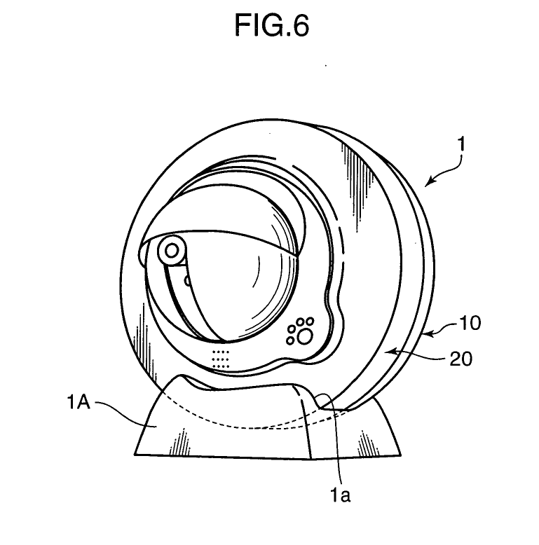

FIG. 6 is a perspective view showing a state of the optical pet guiding apparatus placed on a horizontal surface different from the state hung on a wall. This apparatus 1 has a stand 1A on which the apparatus 1 is placed, and can be stably placed on the stand 1A. The stand 1A has a specified three-dimensional shape, for example, a truncated quadrangular pyramid and is formed with a transversely extending recess la at its upper part. This apparatus 1 can be mounted by being fitted into this recess la in a horizontal posture shown in FIG. 6. It should be noted that a semi-locking configuration such as a projection is provided at a suitable position of the contact surface of the recess la to give a solid feeling.

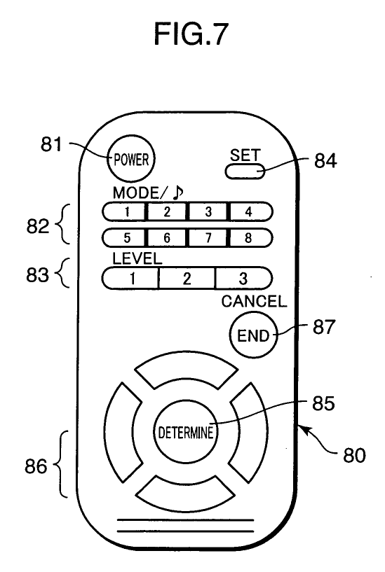

FIG. 7 is a construction diagram of the remote controller for remotely giving an operation instruction to the control unit of the optical pet guiding apparatus. Various operation buttons, i.e. a power button 81 for instructing the power supply to be turned on and off, mode/sound buttons 82 for giving a command for the mode selection and for the sound selection, level/size buttons 83 for setting the training level and the size of a projection range Z0, a setting button 84 for instructing the setting of the calibration, a determine button 85 for instructing the determination of the set content, up-, down-, left- and right-buttons (cross key 86), and a cancel/end button 87 are operably arranged on the outer surface of the casing of the remote controller 80 (corresponding to an operation instructing device). At the leading end (upper side in FIG. 7) of the casing is provided a transmitting section for remotely transmitting a command signal using a medium, for example, such as a light, an electric wave or a supersonic wave. An operation signal processor constructed, for example, by a computer is provided in the casing, and known technologies such as means for judging the operating states of the respective operation buttons, means for converting the content of operation into a corresponding command signal, and means for converting the command signal into a corresponding transmission signal and transmitting the resulting signal are employed.

FIG. 8 is a diagram schematically showing the function block of the optical pet guiding apparatus. The control unit 100 outputs a transverse-direction command signal to the transversely changing section 40 to change the projecting direction along transverse direction and outputs a vertical-direction command signal to the vertically changing section 60 to change the projecting direction along vertical direction, whereby the light beam emitted from the light emitting section 50 is projected within the specified projection range Zo on the floor surface in the form of the spotlight SL.

FIG. 9 is a block diagram of the optical pet guiding apparatus. In FIG. 9, the control unit 100 is constructed by a microcomputer or the like and connected with a ROM 101 storing a control program and various set data, and a RAM 102 for temporarily saving data being processed.

A sound reproducing section 231 is for outputting an audio signal from the control unit 100 to the loudspeaker 23 after converting it into an analog acoustic signal. Motor driving portions 411, 641 are for generating drive signals from drive command signals sent from the control unit 100 to the respective motors 41, 64 and outputting the generated signals.

The control unit 100 is provided with a light controller 110, a sound controller 120, and a direction change controller 130. The light controller 110 includes a start position setting section 111 for setting rotational angle information for the motors 41, 64 assuming, four example, any of four corners of a rectangular area as a start position, i.e. an initial position as the basis for the projection position of the spotlight SL in conformity with the size of a room or the furniture arrangement if the projection range Zo of the light beam (spotlight SL) projected from the apparatus 1 mounted at a position at a specified height from the floor surface; a size setting section 112 for setting the projection range Zo of the spotlight SL; a mode setting section 113 for setting the light projection pattern of the spotlight SL as the rotational angle information for the motors 41, 64; a level setting section 114 for setting ranking depending on the training level for the pet; and a blink controlling section 115 for blinking the spotlight SL.

The sound controller 120 includes a sound effect setting section 121 for setting an audio signal representing words of commands to the pet.

The direction change controller 130 includes a transverse-direction change controlling section 131 for outputting a projection position command with respect to the transverse direction of the light beam (spotlight SL) projected from the apparatus 1 mounted at the position at the specified height from the floor surface to the motor driving portion 411, and a vertical-direction change controlling section 132 for outputting a projection position command with respect to the vertical direction (upward and downward directions) of the light beam (spotlight SL) projected from the apparatus 1 to the motor driving portion 641.

This apparatus 1 is used indoors. Since exercise ranges for pets are limited in some cases due to housing conditions and other reasons, the projection position and the projection range of the light beam are adjusted in conformity with the size of a room and the furniture arrangement. Kinds of the projection range Zo and the projection position data of the light projection patterns are stored in correspondence with the respective modes in the ROM 101.

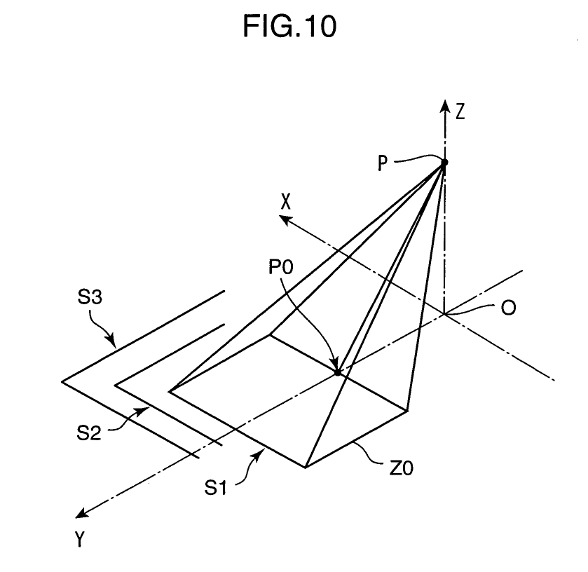

This point is described with reference to FIG. 10 showing the projection range. Assuming that a projection point of the intersection of the light beam with the above two axes of rotation for the direction change on the floor surface is a reference point O of an XYZ space in FIG. 10, the spotlight is moved to a position P0 (on Y-axis) by pressing down the up- and down-buttons of the cross key 86 of the remote controller 80, and this position is determined as an initial position P0. The projection range Zo is selected from sizes S1, S2 and S3 having the initial position P0 as a basis. This selection is made by pressing a number button “1” to “3” in the level/size buttons 83. The dimensions of the sizes S1, S2 and S3 are set beforehand as follows. For example, if the size S1 is 1 square meter large, the size S2 has an analogous figure 1.5 times as large as the size S1 and the size S3 has an analogous figure two times as large as the size S1. The sizes S2, S3 may be enlarged at specified magnifications only along Y-axis direction. It does not matter which one of the setting of the initial position P0 and the selection of the size S precedes the other. In this way, an area within the projection range is set as a training area for the pet.

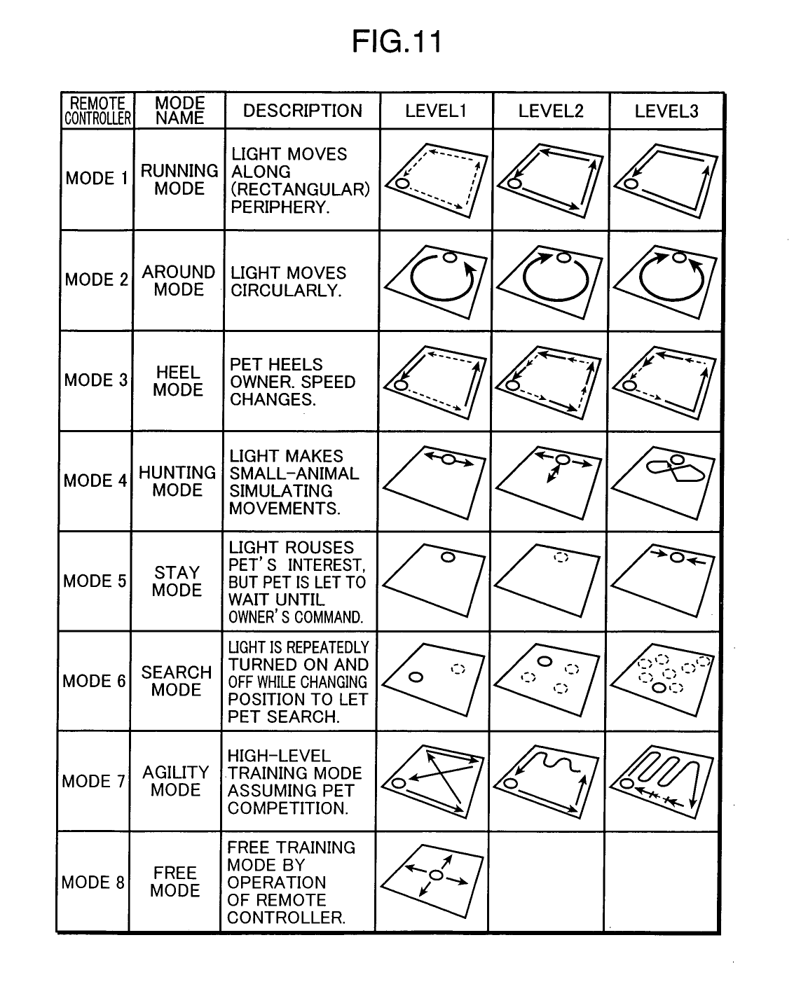

FIG. 11 is a chart showing light projection pattern modes of the spotlight SL within the projection range. A plurality of modes, here eight modes are prepared, and one of them can be selected by selectively pressing down one of number buttons “1” to “8” of the mode/sound buttons 82.

The modes 1 to 7 are set beforehand, whereas the mode 8 is a free mode. In the free mode (mode 8), the projection position is sequentially instructed by an operator himself and is changed in a corresponding direction by pressing the respective buttons of the cross key 86 of the remote controller 80. In this free mode, the moving speed of the spotlight SL can be selected in three stages of low, middle and high speeds by means of the level/size buttons 83 of the remote controller 80.

Levels 1 to 3 confirming to degrees of training difficulty are ranked in each mode 1 to 7. The level 1 is a beginner level, the level 2 an intermediate level and the level 3 an advanced level. Each level can be selected by pressing down a corresponding one of the number buttons “1” to “3” of the level/size buttons 83 of the remote controller 80.

Movements of the projection position (movement paths of the light projection patterns) in the respective modes are stored in the ROM 101 beforehand as rotational angle data continuous in time measuring direction with respect to the motors 41, 64 with the size S1 as a basis. The position of the spotlight SL moves on the floor surface by successively reading these data in time measuring direction after the start of the movement. For the sizes S2, S3, the rotational angle data for the motors 41, 64 are geometrically calculated in real time in accordance with the size ratio. Alternatively, the rotational angle data for the motors 41, 64 in the respective sizes may be calculated beforehand and may be stored in the ROM 101. In a real-time calculation mode, the sizes are not limited to stepwise ones, and conversion equations between the sizes may be stored beforehand and the size may be continuously changed by utilizing these equations.

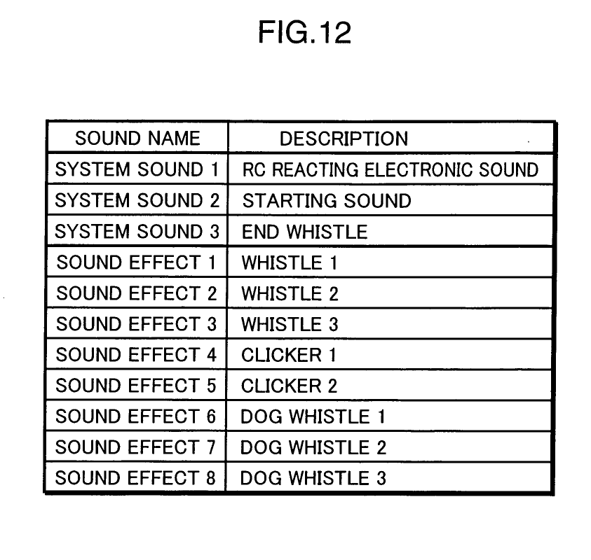

Blinking operations of the luminescence source 52 in response to the blink controlling section 115 are also stored in the ROM 101 in correspondence with the respective modes and the respective levels. Sounds and sound effects in response to the sound controller 120 are also stored in the ROM 101 in correspondence with the respective modes and levels. Kinds of sounds are shown in FIG. 12. Here, system sounds 1 to 3 and various sound effects 1 to 8 simulating finger flutes and the like are stored in the ROM 101 beforehand. The sound effects can be also instructed by the operator and, in this case, one sound effect can be selected from a plurality of kinds of sound effects prepared beforehand, here sound effects having eight kinds of tone qualities by pressing down any one of the number buttons “1” to “8” of the mode/sound buttons 82 of the remote controller 80. Blinking positions and sound-effect generating positions may correspond to the position data of the light projection pattern or may be set based on times from the start. For example, if the light projection pattern is a rectangular path of the light, sound effects are given immediately before the light reaches each of four corners of the rectangular path and, by repeating this, the pet is conditioned to notice that the moving direction of the light changes. In this way, the pet is simulated both visually and acoustically, thereby rousing an interest in chasing the light path. In a mode set based on time, timing information given by a built-in timer may be used.

In FIG. 11, arrowed dotted lines represent paths of the spotlight SL continuously moving in arrow directions at a specified low speed; arrowed solid lines represent paths of the spotlight SL continuously moving in arrow directions at a specified middle or high speed; a solid line having arrows at both ends represents a path of reciprocating movements; and circles represent jumping modes (as if momentarily disappearing) of insects or the like on the floor surface that a movement is done in a state of being turned off (or at the same positions) and turn-on is done at the corresponding position after the lapse of time. It should be noted that so-called zigzag movements of shaking in directions normal to the moving direction may be added to the paths shown in FIG. 11.

It should be noted that the shape of the spotlight SL can be made into a specified shape (such as the shape of an insect) other than the circular one by mounting a plate formed with an arbitrarily shaped hole at the outer side of the lens 53.

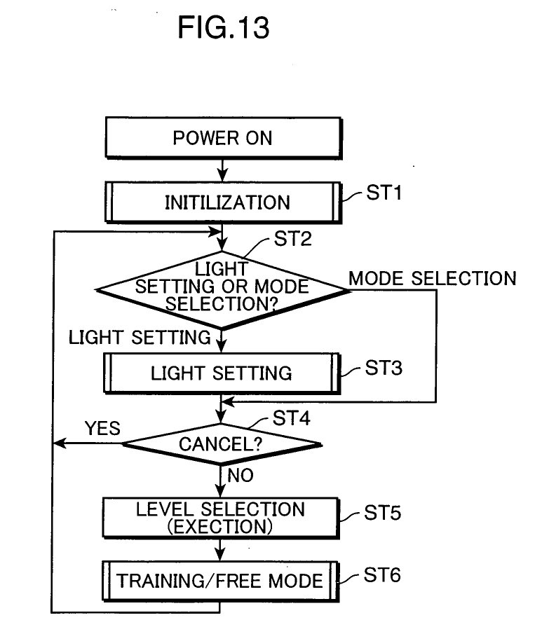

FIG. 13 is a flow chart showing a main operation of the optical pet guiding apparatus. It should be noted that this apparatus 1 is installed on a room wall. Now, if this apparatus 1 is turned on by pressing the power button 81 of the remote controller 80, “initialization” is carried out (Step ST1).

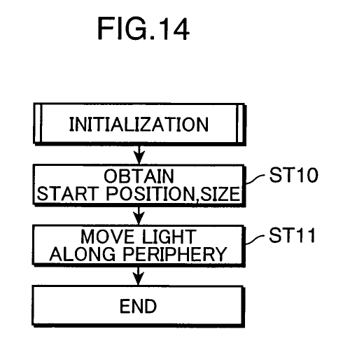

FIG. 14 is a flow chart showing a subroutine “Initialization”. First, a position set beforehand such as defaults or the start position P0 set last time and a size set beforehand such as defaults or a size selected last time are obtained (Step ST10) and, subsequently, the light beam is shaken to move the spotlight SL along the periphery of the projection range to notify the range of the set size (Step ST11).

Referring back to FIG. 13, whether or not the setting button 84 of the remote controller 80 has been pressed down is then judged (Step ST2). A subroutine “Light Setting” is carried out (Step ST3) if the setting button 84 has been pressed down, whereas the mode corresponding to the number of the pressed-down button is selected if one of the mode/sound buttons 82 has been pressed down.

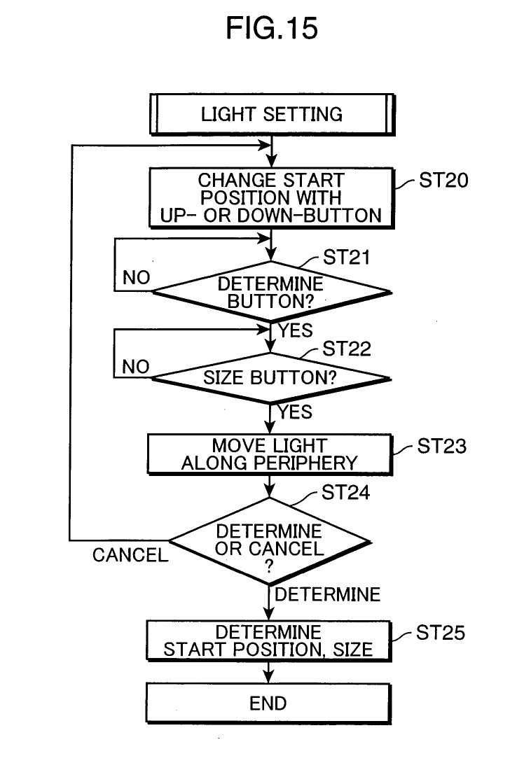

FIG. 15 is a flow chart showing the subroutine “Light Setting”. First, whether or not the up- or down-button of the cross key 86 of the remote controller 80 has been pressed down is judged. If the judgment result is affirmative, the light beam is accordingly shaken to move the spotlight SL along the Y-axis to change the initial position P0 (Step ST20). Here, if the determine button 85 is pressed down, a new initial position P0 is determined (Step ST21). Subsequently, whether or not any one of the level/size buttons 83 has been pressed down (Step ST22) is judged, and the spotlight SL is moved along the periphery of the selected size (Step ST23) if the judgment result in Step ST22 is affirmative.

Upon completing the size selection, whether or not the determine button 85 has been pressed down is judged (Step ST24), and the setting of the start position P0 and the size selection are determined (Step ST25) if the determine button 85 is pressed down. On the other hand, if the operator notices the need for a change while confirming the movement of the spotlight SL along the periphery, the cancel button 87 is pressed down to return to Step ST20, where the setting of the start position and the size selection are redone.

Referring back to FIG. 13, whether or not the cancel button 87 has been pressed down is then judged (Step ST4). Unless the cancel button 87 has been pressed down, whether or not any one of the number buttons “1” to “3” of the level/size buttons 83 of the remote controller 80 has been pressed down is then judged, and the level corresponding to the pressed-down button is set (Step ST5). Subsequently, actual training (free mode if the mode 8 was selected) is started in accordance with the setting and the selected contents (Step ST6).

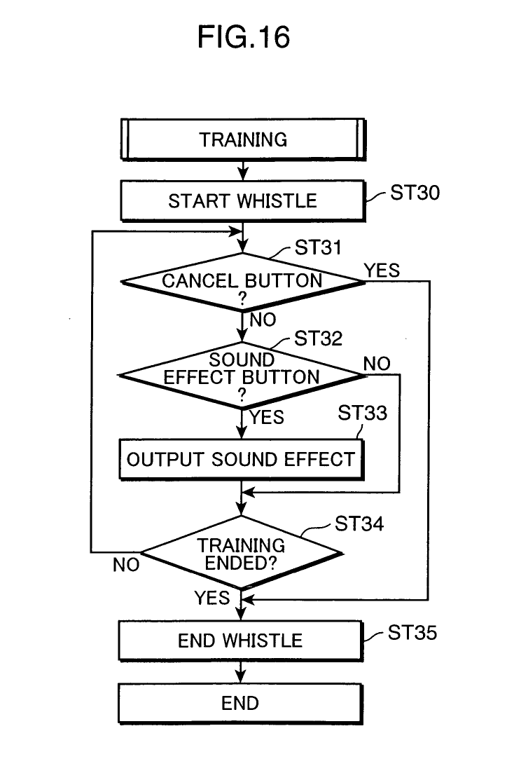

FIG. 16 is a flow chart showing a subroutine “Training”. When the training mode is started, the system sound 1, which is an electronic sound, is given forth as a start whistle from the loudspeaker 23 (Step ST30) and then whether or not the cancel button 87 has been pressed down is judged (Step ST31). Unless the cancel button 87 has been pressed down, whether or not any of the number buttons “1” to “8” of the mode/sound buttons 82 has been pressed down is judged (Step ST32). If the judgment result in Step S32 is affirmative, the sound effect corresponding to this number is selected from the sound effects 1 to 8 and the corresponding sound effect is given forth from the loudspeaker 32 (Step ST33). Subsequently, whether or not the training has ended is judged (Step ST34), and this subroutine returns to Step ST31 unless the training has ended while proceeding to Step ST35 if the training has ended. Similarly, this subroutine proceeds to Step ST35 also when the cancel button 87 is pressed down. In Step ST35, the system sound 3, which is an electronic sound, is given forth as an end whistle from the loudspeaker 23, thereby ending this subroutine.

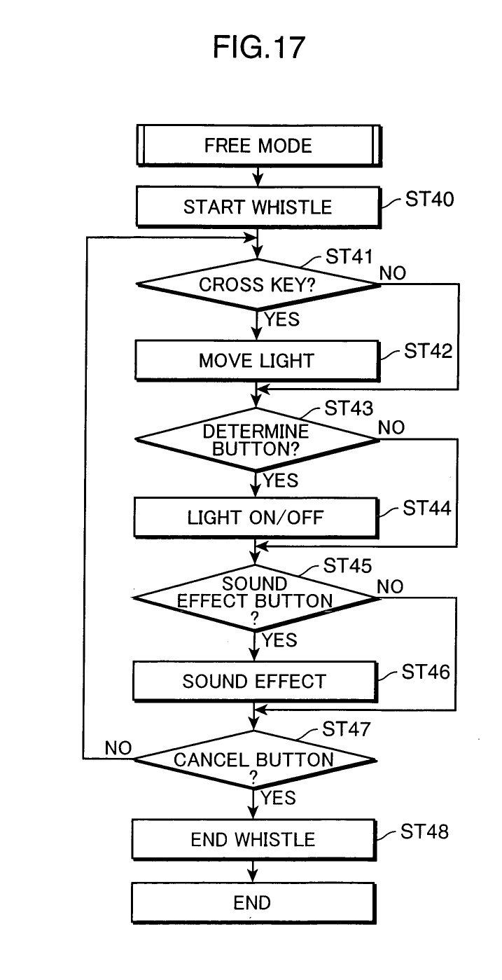

FIG. 17 is a flow chart showing a subroutine “Free Mode”. When the free mode is started, a start whistle is first given forth (Step ST40) and whether or not a specified button of the cross key 86 has been pressed down is judged (Step ST41). If this button has been pressed down, the spotlight SL is moved in upward, downward, leftward or rightward direction corresponding to this button (Step ST42).

Subsequently, whether or not the determine button 85 has been pressed down is judged (Step ST43), and the luminescence source 52 (light) is blinked (Step ST44) if the determine button 85 has been pressed down. Then, whether or not any of the number buttons “1” to “8” of the mode/sound buttons 82 has been pressed down is judged (Step ST45) and one of the sound effects 1 to 8 corresponding to the number of the pressed-down button is selected and given forth (Step ST46) if the judgment result in Step ST45 is affirmative.

Subsequently, whether or not the cancel button 87 has been pressed down is judged (Step ST47). The system sound 3, which is an electronic sound, is given forth as an end whistle from the loudspeaker 23 (Step ST48), thereby ending this subroutine if the cancel button 87 has been pressed down, whereas this subroutine returns to Step ST41 unless the cancel button 87 has been pressed down.

The present invention can also be embodied as follows.

(1) The constructions of the transversely changing section 40 and the vertically changing section 60 may be reversed. Specifically, a rotary shaft is provided in the transverse direction of the spherical body 32 and the tubular body of the light emitting section 50 may be provided with a vertical rotary shaft.

(2) The respective training modes may be set utilizing the built-in timer instead of repeating the light projection pattern one or a specified number of times.

(3) Whether or not the pet is moving along the light projection pattern may be judged by laying a mat or a sheet body in which a sensor for detecting the weight within the projection range or detecting and monitoring the movement of the pet by means of a monitor camera, and a sound effect may be given forth, the light projection pattern may be changed or the movement of the spotlight SL may be stopped depending on the judgment result.

(4) The operation instructing function of the remote controller 80 may be provided at a specified position of the outer surface of the apparatus main body including the light emitting section 50.

(5) The luminescence source 52 may be constructed to generate lights of a plurality of colors, so that the beam light changes its color for each light projection pattern or may suitably change its color in the light projection pattern. Further, if the luminescent color can be selected based on the kind of the pet and the color of the floor, the guiding function can be more effectively exhibited.

(6) A transparent cover having such a spherical shape extending from the outer wall of the eave 22 may be attached to the opening 21 in order to prevent the damage of the mechanical parts (motors, etc.) caused by external forces and to prevent the entrance of dirt, dust and the like.

(7) The shape of the hollow spherical body 32 is not limited to the spherical shape, and only the front half may be spherical or the shape does not particularly matter provided that the spherical body 32 is a hollow body capable of rotating about one axis, rotatably supporting the light emitting section 50 inside and accommodating the direction changing section for rotating the light emitting section.

As described above, an inventive optical pet guiding apparatus comprises a light emitter for emitting a light beam in a specified direction, a direction changer for changing the facing direction of the light emitter in a two-dimensional direction, and a drive controller for causing the direction changer to change the facing direction of the light emitter, these elements being provided in an apparatus main body, the drive controller including a first rotator for rotating the light emitter about a first shaft and a second rotator for rotating the light emitter about a second shaft normal to the first shaft, and the drive controller rotating the first and second rotators, respectively.

With this construction, the light emitter is constructed such that the light beam emitting direction can be changed by the direction changer, and the facing direction thereof is changed in accordance with a command upon receiving such a command to change the facing direction from the drive controller. Specifically, the light beam is turned about the first shaft if the first rotator is driven while being turned about the second shaft if the second rotator is driven. The light beam can be projected in a desired direction within a specified projection range by driving the first and second rotators by suitable amounts.

Preferably, the first rotator is supported in the apparatus main body and includes a first driving portion for generating a power, a hollow body rotatably supported in the apparatus main body via the first shaft, and a first power transmitting portion for transmitting the power of the first driving portion to the hollow body, and the light emitter and the second rotator are arranged inside the hollow body, the hollow body having a projection window through which the light beam from the light emitter passes. With this construction, the power of the first driving portion is transmitted to the hollow body via the first power transmitting portion, thereby rotating the hollow body about the first shaft. Since the light emitter is arranged in the hollow body, the light emitter rotates as the hollow body is rotated. Further, since the second rotator is arranged in the hollow body, the light emitter is rotated about the second shaft in this hollow body to project a light through the projection window.

Preferably, the second rotator includes a second driving portion supported in the hollow body and adapted to generate a power, and a second power transmitting portion for transmitting the power of the second driving portion to the light emitter rotatably supported in the hollow body via the second shaft. With this construction, the power of the second driving portion is transmitted to the hollow body via the second power transmitting portion, thereby rotating the hollow body about the second shaft.

Preferably, the light emitter includes a bottomed tubular body, and a luminescence source disposed at the bottom of the tubular body for emitting a light beam in a direction toward the opening of the tubular body, and the second shaft rotatably supports the tubular body while extending in a direction normal to an axial direction of the tubular body. With this construction, the light beam emitting direction can be changed by rotating the tubular body via the second shaft.

Preferably, the apparatus further comprises an operation instructing device externally operable, separate from the apparatus main body, and including a transmitter for remotely transmitting a drive command to the drive controller, and the apparatus main body includes a receiver for receiving the drive command from the operation instructing device. With this construction, the light beam emitting direction can be remotely changed by an operator operating the operation instructing device.

Preferably, the operation instructing device includes a range setter for setting a projection range of the light beam. With this construction, the projection range of the light beam is set by the operation instructing device. Thus, a suitable projection range can be set in accordance with the room space, the furniture arrangement and the like.

Preferably, the drive controller includes a light projection pattern storage device for storing a plurality of kinds of light projection patterns within a projection range of the light beam, and the operation instructing device includes a pattern selector for selecting the light projection pattern. With this construction, a desired one can be selected from a plurality of kinds of light projection patterns (how the light beam is moved) prepared beforehand by the operation instructing device. By making the plurality of light projection patterns selectable, playgames and exercises of pets can be assisted while preventing the pets from getting bored.

Preferably, the apparatus further comprises a lighting pattern storage device for storing lighting patterns of the light emitter in correspondence with the light projection patterns, and a lighting controller for executing a blinking operation in the corresponding lighting pattern in conjunction with a light projecting operation of the selected light projection pattern, both elements being provided in the apparatus main body. With this construction, the blinking operation in the lighting pattern specifying the blinking of the light emitter is executed in correspondence with the light projection pattern. Therefore, movements simulating as if an insect would have jumped (when the light is turned off) can be presented to pets.

Preferably, the apparatus further comprises a sound generator for generating a sound effect, a sound effect pattern storage device for storing sound effect patterns of the sound generator in correspondence with the light projection patterns, and a sound effect controller for executing a sound generating operation in the corresponding sound effect pattern in conjunction with a light projecting operation of the selected light projection pattern, these elements being provided in the apparatus main body. With this construction, the sound generating operation in the sound effect pattern for sound effects given forth from the sound generator is executed in correspondence with the light projection pattern. Therefore, pets are acoustically instructed and have their interests roused at the start and end of a guiding operation and other suitable timings.

This application is based on patent application No. 2005-278796 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An optical pet guiding apparatus, comprising a light emitter for emitting a light beam in a specified direction, a direction changer for changing the facing direction of the light emitter in a two-dimensional direction, and a drive controller for causing the direction changer to change the facing direction of the light emitter, these elements being provided in an apparatus main body, the direction changer including a first rotator for rotating the light emitter about a first shaft and a second rotator for rotating the light emitter about a second shaft normal to the first shaft, and the drive controller rotating the first and second rotators, respectively.

2. An optical pet guiding apparatus according to claim 1, wherein the first rotator is supported in the apparatus main body and includes a first driving portion for generating a power, a hollow body rotatably supported in the apparatus main body via the first shaft, and a first power transmitting portion for transmitting the power of the first driving portion to the hollow body, and the light emitter and the second rotator are arranged inside the hollow body, the hollow body having a projection window through which the light beam from the light emitter passes.

3. An optical pet guiding apparatus according to claim 2, wherein the light emitter includes a bottomed tubular body, and a luminescence source disposed at the bottom of the tubular body for emitting a light beam in a direction toward the opening of the tubular body, and the second shaft rotatably supports the tubular body while extending in a direction normal to an axial direction of the tubular body.

4. An optical pet guiding apparatus according to claim 2, wherein the second rotator includes a second driving portion supported in the hollow body and adapted to generate a power, and a second power transmitting portion for transmitting the power of the second driving portion to the light emitter rotatably supported in the hollow body via the second shaft.

5. An optical pet guiding apparatus according to claim 4, wherein the light emitter includes a bottomed tubular body, and a luminescence source disposed at the bottom of the tubular body for emitting a light beam in a direction toward the opening of the tubular body, and the second shaft rotatably supports the tubular body while extending in a direction normal to an axial direction of the tubular body.

6. An optical pet guiding apparatus according to claim 5, further comprising an operation instructing device externally operable, separate from the apparatus main body, and including a transmitter for remotely transmitting a drive command to the drive controller, and the apparatus main body includes a receiver for receiving the drive command from the operation instructing device.

7. An optical pet guiding apparatus according to claim 6, wherein the drive controller includes a light projection pattern storage device for storing a plurality of kinds of light projection patterns within a projection range of the light beam, and the operation instructing device includes a pattern selector for selecting the light projection pattern.

8. An optical pet guiding apparatus according to claim 6, wherein the operation instructing device includes a range setter for setting a projection range of the light beam.

9. An optical pet guiding apparatus according to claim 8, wherein the drive controller includes a light projection pattern storage device for storing a plurality of kinds of light projection patterns within a projection range of the light beam, and the operation instructing device includes a pattern selector for selecting the light projection pattern.

10. An optical pet guiding apparatus according to claim 9, further comprising a lighting pattern storage device for storing lighting patterns of the light emitter in correspondence with the light projection patterns, and a lighting controller for executing a blinking operation in the corresponding lighting pattern in conjunction with a light projecting operation of the selected light projection pattern, these elements being provided in the apparatus main body.

11. An optical pet guiding apparatus according to claim 10, further comprising a sound generator for generating a sound effect, a sound effect pattern storage device for storing sound effect patterns of the sound generator in correspondence with the light projection patterns, and a sound effect controller for executing a sound generating operation in the corresponding sound effect pattern in conjunction with a light projecting operation of the selected light projection pattern, these elements being provided in the apparatus main body.

12. An optical pet guiding apparatus according to claim 9, further comprising a sound generator for generating a sound effect, a sound effect pattern storage device for storing sound effect patterns of the sound generator in correspondence with the light projection patterns, and a sound effect controller for executing a sound generating operation in the corresponding sound effect pattern in conjunction with a light projecting operation of the selected light projection pattern, these elements being provided in the apparatus main body.

13. An optical pet guiding apparatus according to claim 1, wherein the light emitter includes a bottomed tubular body, and a luminescence source disposed at the bottom of the tubular body for emitting a light beam in a direction toward the opening of the tubular body, and the second shaft rotatably supports the tubular body while extending in a direction normal to an axial direction of the tubular body.

14. An optical pet guiding apparatus according to claim 1, further comprising an operation instructing device externally operable, separate from the apparatus main body, and including a transmitter for remotely transmitting a drive command to the drive controller, and the apparatus main body includes a receiver for receiving the drive command from the operation instructing device.
